(19) United States
(12) Patent Application Publication
(10) Pub. No.: US 2002/0039433 A1
(43) Pub. Date: Apr. 4, 2002

(54) Iris identification system and method and computer readable storage medium stored therein computer executable instructions to implement iris identification method

(76) Inventor: Sung Bok Shin, Kung-gi Do (KR)

Correspondence Address: PENNIE AND EDMONDS, 1155 AVENUE OF THE AMERICAS, NEW YORK, NY, 100362711

(21) Appl. No.: 09/962,751

(22) Filed: Sep. 24, 2001

(30) Foreign Application Priority Data
Jul. 10, 2000 (KR) 2000-59099

(51) Int. Cl. G06K 9/00

(52) U.S. Cl. 382/117

(57) ABSTRACT

An iris identification system includes a mode converter for selecting one of registration and identification modes, an image input means for capturing an iris image, an image control unit for registering a plurality of instances of the iris image captured in the image input means as reference iris images in the registration mode and retrieving a corresponding reference iris image when an iris image is presented to the image input means in the identification mode, an iris reference iris image storage for storing the registered reference iris images, and a main control unit for controlling the image input means, mode converter, image control unit and the iris reference iris image storage so as to cooperates one another.

### BACKGROUND OF THE INVENTION

(a) Field of the Invention

A present invention relates to an iris recognition technology for identifying person and, in particular, to an iris identification system and method, and a computer readable storage medium stored therein computer executable instructions to implement the iris identification method, that are capable of improving an iris recognition accuracy using reference iris images, per person, taken in various environments.

(b) Description of the Related Art

Recently, various biometric identification technologies using fingerprint, voice, iris, and vein patterns have been developed. Among them, the iris identification technology is known to provide the most secure identification reliability in the security field.

Such an iris identification technology is well known in the art as disclosed by International Publication No. WO94/9446 entitled “Biometric Personal Identification System Based On Iris Analysis.”

This prior art discloses the iris identification technique which is performed in such a way of acquiring an image of the eye to be analyzed in digital form suitable for analysis, defining and isolating the iris portion of the image, analyzing the defined area of the image so as to produce an iris code, storing the iris code as a reference code, and comparing a presented code with the reference code to obtain a Hamming distance through the exclusive-OR logical operation. The Hamming distance is used in order to determine the identity of a person and to calculate confidence level for the decision.

However, this prior art has some drawbacks in that it is difficult to consistently adopt the polar coordinates system to the iris identification since the pupil 2 is constricted when exposed to bright light and expanded in dim light (see FIG. 1a) and the constriction/expansion degree to the light differs in every person because each person has his/her own characteristics in sphincter pupillae, dilator pupillae, intraocular pressure, and etc., such that it is also difficult to predict how an iris characteristic factor of the iris 1 changes when the pupil 2 expands (see FIG. 1b). Referring to FIG. 1b, when an iris image having a characteristic factor 3 is presented and compared with one of the reference images, it might be determined that there is no identical reference image.

Also, since the iris identification of the prior art divides the iris image so as to define annular analysis portions, this identification accuracy considerably decreases when this technique is used for Asian people whose eye is exposed a little relative to the westerners. If narrowing the analysis band in order to prevent this problem, security reliability is seriously degraded.

Furthermore, this prior art iris identification technique has no algorithm capable of preventing misidentification by an inorganic fake iris.

### SUMMARY OF THE INVENTION

The present invention has been made in an effort to solve the above problems of the prior art.

It is an object of the present invention to provide an iris identification system and method capable of reducing misidentification rate by taking several reference iris images captured from one iris in various luminance environments and repeatedly comparing a presented iris data to each of the reference iris images.

It is another object of the present invention to provide an iris identification system and method capable of reducing analysis denial rate regardless of exposure amount of an eye by dividing an iris image into a plurality of blocks having respective priorities so as to analyze the iris image from a block having the highest priority in descendent order.

It is still another object of the present invention to provide a computer readable storage medium stored thereon computer executable instructions to implement the iris identification method.

To achieve the above objects, the iris identification system of the present invention comprises a mode converter for selecting one of registration and identification modes, an image input means for capturing an iris image, an image control unit for registering a plurality of instances of the iris image captured in the image input means as reference iris images in the registration mode and retrieving a corresponding reference iris image when an iris image is presented to the image input means in the identification mode, an iris reference iris image storage for storing the registered reference iris images, and a main control unit for controlling the image input means, mode converter, image control unit and the iris reference iris image storage so as to cooperates one another,

To achieve the above objects, the iris identification method of the present invention comprises the steps of taking a plurality of iris images from a human eye through an input means, classifying the iris images into at least one class, registering the iris images to corresponding classes as reference iris images per the human eye, storing the reference iris images in a storage medium, receiving a plurality of iris instances of a person for identification, retrieving target reference iris image by comparing each iris instance to reference iris images in a corresponding class, determining whether the iris instance is identified or denied.

To achieve the above objects, the computer readable storage medium computer executable instructions to implement an iris identification method, the iris identification method comprising the processes of taking a plurality of iris images from a human eye through an input means, classifying the iris images into at least one class, registering the iris images to corresponding classes as reference iris images per the human eye, storing the reference iris images in a storage medium, receiving a plurality of iris instances of a person for identification, retrieving target reference iris image by comparing each iris instance to reference iris images in a corresponding class, determining whether the iris instance is identified or denied.

### BRIEF DESCRIPTION OF THE DRAWINGS

The accompanying drawings, which are incorporated in and constitute a part of the specification, illustrate an embodiment of the invention, and together with the description, serve to explain the principles of the invention.

FIG. 1a and FIG. 1b are drawings for illustrating of identification-failing risk in a prior art iris identification system;

FIG. 2 is a block diagram illustrating an iris identification system according to a preferred embodiment of the present invention;

FIG. 3 is a drawing for illustrating a process of comparing an input iris image to reference iris images in the iris identification system of FIG. 2;

FIG. 4a and FIG. 4b are a set of drawings for illustrating how an iris image is classified;

FIG. 5 is a diagrammatic view for illustrating the iris vertically partitioned and assigned with priorities;

FIG. 6 is a diagrammatic view for illustrating the iris sectored in each band of FIG. 5;

FIG. 7a to 7d is a drawing for illustrating how a center of the pupil of the iris image is obtained by the registration module;

FIG. 8a is a graph illustrating auxiliary data on a standard image luminance axis;

FIG. 8b is a graph illustrating main data on the standard image luminance axis;

FIG. 8c is a graph illustrating negative main data on the standard image luminance axis;

FIG. 8d is a graph illustrating compensated auxiliary data on the standard image luminance axis;

FIG. 9 is a flowchart for illustrating a reference iris image-registering process of an iris identification method according to the present invention;

FIG. 10a is a flowchart for illustrating an image-taking step of the reference iris image-registering process of FIG. 9;

FIG. 10b is a flowchart for illustrating a luminance compensation routine of the image-taking step of FIG. 10a;

FIG. 10c is a flowchart for illustrating an iris image-partitioning routine of the reference iris image-registering process of FIG. 9; and

FIG. 11 is a flowchart for illustrating an identification process of the iris identification method of the present invention.

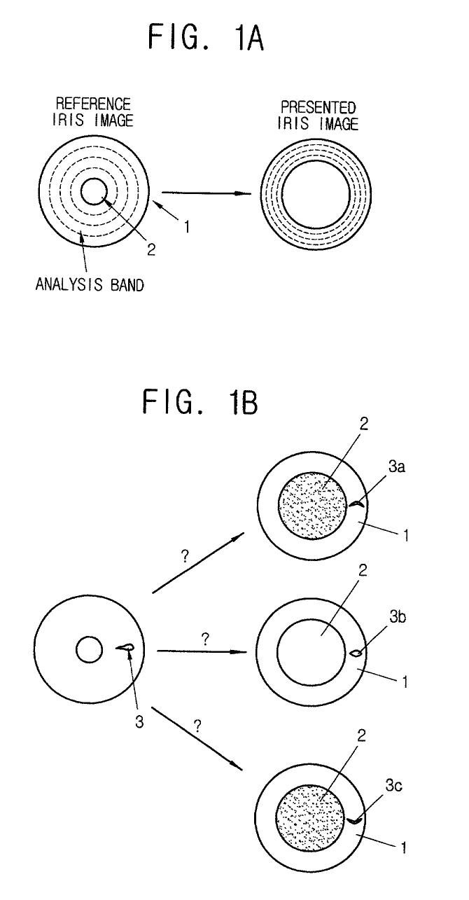

### DETAILED DESCRIPTION OF THE PREFERRED EMBODIMENTS

A preferred embodiment of the present invention will be described hereinafter with reference to the accompanying drawings.

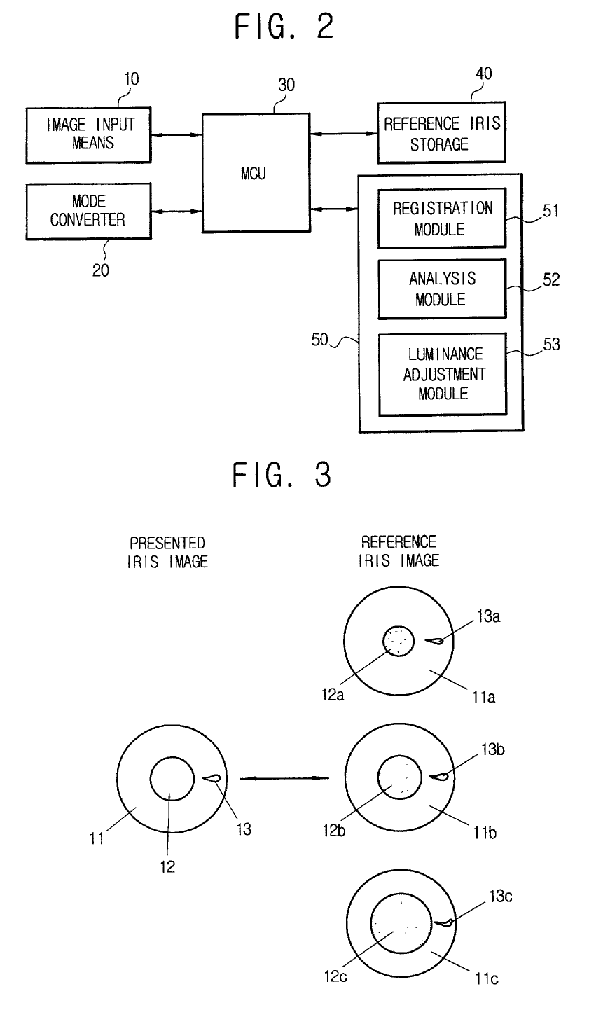

FIG. 2 shows an iris identification system according to a preferred embodiment of the present invention.

As shown in FIG. 2, the iris identification system comprises an image input means 10, a mode converter 20, a main control unit (MCU) 30, an iris reference iris image storage 40, and an image control unit 50.

The image input means 10 comprises a camera for capturing an iris image and an image-processing module (not shown).

The mode converter 20 comprises a keyboard (not shown) on which a user selects one of sample-registering and -identification modes that are respectively for registering an input iris image as a reference iris image and for identifying the input iris image by comparing with the previously registered reference iris images.

The iris reference iris image storage 40 stores the registered iris samples under control of the MCU 30.

The image control unit 50 comprises a sample-registering means 51 for capturing a plurality of iris instances from the iris presented to the image input means 10 in various luminance environments and registering the iris instances as reference iris images per person in the sample-registering mode, an image analysis module 52 for comparing a presented image from the image input means 10 with the reference iris images and analyzing similarities between the presented image and the reference iris images so as to verify identification in the identification mode, and a luminance adjustment module 53 for detecting a luminance of the input image and adjusting a brightness around the iris if the luminance is higher or lower than a predetermined luminance level.

The MCU 30 controls the image control unit 50 in order for the registration module 51 of the image control unit 50 to classify iris instances from the image input means 10, to register the iris instances as the reference iris, and to store the registered reference iris images in the iris reference iris image storage 40 in the registration mode, and in order for the image analysis module 52 of the image control unit 50 to compare the presented image from the image input means 10 with the reference iris images and to analyze similarities between the presented image and the reference iris images so as to verify identification in the identification mode. Also, the MCU 30 controls the luminance adjustment module 53 of the image control unit 50 in order for the luminance adjustment module 53 detects luminance of the input image so as to adjust the light amount radiating to the iris when the luminance is higher or lower than a predetermined luminance level.

The MCU 30 can be structured so as to integrate the iris reference iris image storage 40 and the image control unit 50.

The luminance adjustment module 53 adjusts intensity of visible ray around an eyepiece (not shown) of the image input means 10 so as to be able to adjust a pupil radium of an eye to be captured as iris instances or presented iris image. Also, the luminance adjustment module 53 can further adjust the luminous intensity by radiating invisible ray when the adjusted intensity of visible ray is less than a predetermined intensity.

The registration module 51 takes several iris instances having respective pupil radius from an individual iris, registers the iris instances as the reference iris images at corresponding classes that are classified according to the pupil radius and stores the registered reference iris image in the iris reference iris image storage 40.

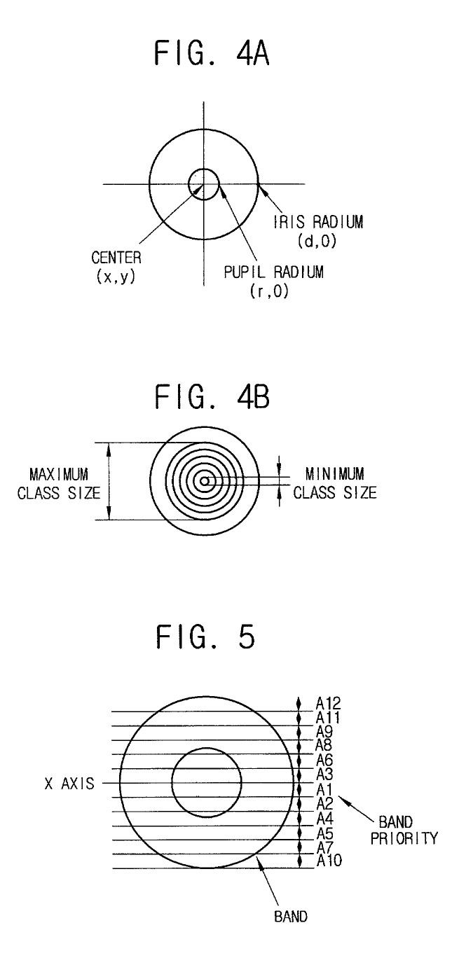

FIG. 3 is a drawing for illustrating a process of comparing an input iris image to reference iris images stored in the iris reference iris image storage 40 and FIG. 4a and FIG. 4b are a set of drawings for illustrating how an iris image is classified.

Referring to FIG. 4a and FIG. 4b, the iris image is distinguished according to a size of pupil dilating in the iris where r is pupil radium and d is iris radium (d>r). That is, the class is determined by the constant “r” which increases to a maximum value in the iris radium “d”. A whole class range β can be expressed as follows.

$$\frac{1}{5} \leq ( β = \frac{\vert d \vert - \vert r \vert}{\vert r \vert} ) \leq \frac{4}{5}$$

$$x = \frac{β}{n}$$

where, n is number of class, and x is range of each class.

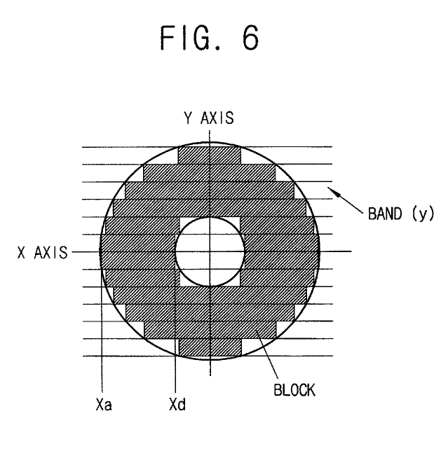

FIG. 5 is a diagrammatic view for illustrating the iris image vertically partitioned and assigned with priorities and FIG. 6 is a diagrammatic view for illustrating the iris sectored in each band of FIG. 5.

As shown in FIG. 5, the iris image is vertically partitioned up and down on the basis of a horizontal axis x at a predetermined interval and each band is assigned with a priority corresponding to the band (for example, A1>A2A3, . . . , A10>A11>A12) in the registration module 51. The priority is assigned from the band near the horizontal axis x to the band contacting to an exterior iris boundary in the descendent order such that the band just below the horizontal axis x has the highest priority. Also, the priority is assigned alternately in such an order of A1, A2, A4, A5, A7, A10 in downward direction and A3, A6, A8, A9, All, A12 in upward direction.

Referring to FIG. 6, the bands are horizontally divided by a perpendicular line (y axis) passing the center of the pupil such that each band forms a pair of symmetrical blocks. Each block is defined by the vertical width of the band and exterior iris radium and pupil radium such that the block having the highest priority is defined by the band width and the horizontal length from Xₐ to X_{d}. A maximum horizontal length of a block can be expressed as following inequality.

|X_{d}|<|max X|<|Xₐ|(only, |Xₐ|>|X_{d}|)

Thus, a maximum dimension maxT of the block can be calculated as following equation.

max T=(|X_{d}|−|Xₐ|)y

wherein y is a vertical width of each band.

The registration module 51 determines a pupil boundary by calculating an average luminance (Iₘₐ, I_{mb}) by averaging luminance (Iₐ, I_{b}) of pixels of the iris image. The average luminance is calculated by following equation 1.

<Equation 1>

When Iₘᵢₙ<I_{b}<Iₘₐ,

$${I}_{mb} = \frac{1}{{N}_{b}} \sum {I}_{b}$$

$$where {I}_{ma} = \frac{1}{{N}_{a}} \sum {I}_{a} , {I}_{a} ( {I}_{b} )$$

is luminance of a pixel, Iₘₐ(I_{mb}) is an average luminance, Nₐ(N_{b}) is number of executions, and Iₘᵢₙ is a minimum luminance limit.

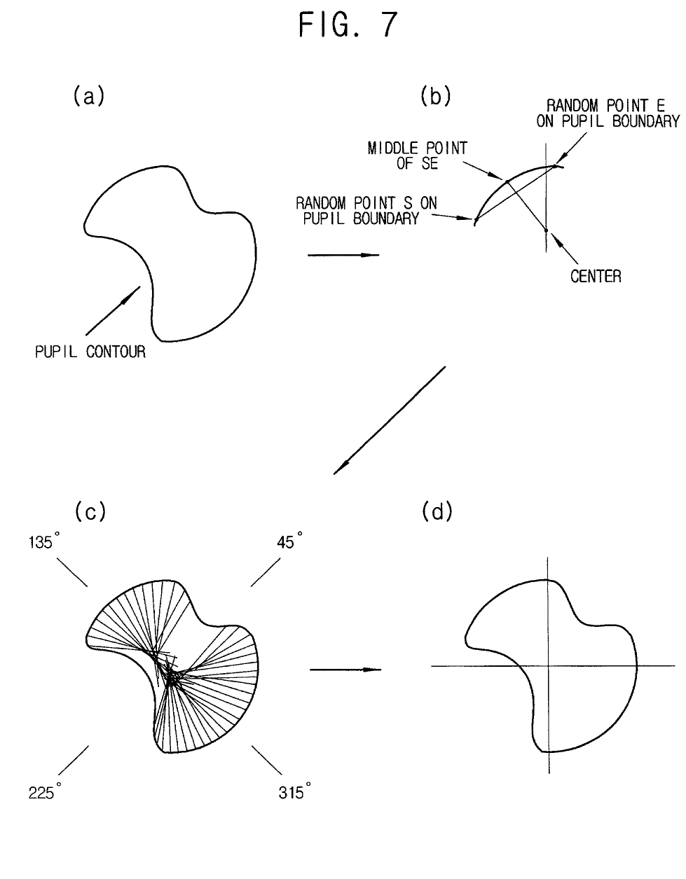

FIG. 7a to FIG. 7d are a set of drawings for illustrating how a center of the pupil of the iris image is obtained by the registration module.

Referring to FIG. 7, once an iris image is taken, two points of S(x₁, y₁) and E(x₂, y₂) are randomly selected on the pupil boundary of the iris image so as to create a segment SE by drawing a line connecting the points S and E. Then, a imaginary perpendicular line is drawn from a center of the segment SE such that the perpendicular line crosses the pupil boundary at a point C(x₃, y₃). A random center I,(x₀, y₀) of the pupil is calculated by the following equation 2a.

<Equation 2a>

$$a = \frac{1}{2} \sqrt{{( {x}_{1} - {x}_{2} )}^{2} + {( {y}_{1} - {y}_{2} )}^{2}}$$

$$c = \frac{1}{2} \sqrt{{( {x}_{1} + {x}_{2} - 2 {x}_{3} )}^{2} + {( {y}_{1} + {y}_{2} - 2 {y}_{3} )}^{2}}$$

$$d = \frac{1}{2 c} ( {a}^{2} - {c}^{2} ) , \\ D = {tan}^{- 1} ( \frac{{y}_{1} - {y}_{2}}{{x}_{1} - {x}_{2}} ) - \frac{π}{2}$$

$${x}_{0} = d \cdot cos D + \frac{1}{2} ( {x}_{1} + {x}_{2} )$$

$${y}_{0} = - ( d \cdot sin D + \frac{1}{2} ( {y}_{1} + {y}_{2} ) )$$

The registration module 51 calculates a plurality of candidate centers I_{I} of the pupil using the equation 2a and extracts the candidate centers (x₀ᵢ, y_{0i:}) of which radius are in the whole class range β. These candidate centers are used in order to obtain a final pupil center Tₚ(xₚ, yₚ). The final pupil center Tₚ is calculated as following equation 2b.

<Equation 2b>

$${x}_{p} = \frac{1}{n} \sum {x}_{0 i} , {y}_{p} = \frac{1}{n} \sum {y}_{0 i}$$

Also, on the basis of the final pupil center Tₚ, a coordinates (xₘ, yₘ) of a pupil boundary is calculated as following equation 2c.

Also, the registration module 51 determines iris boundary and iris radium using the equation 2c.

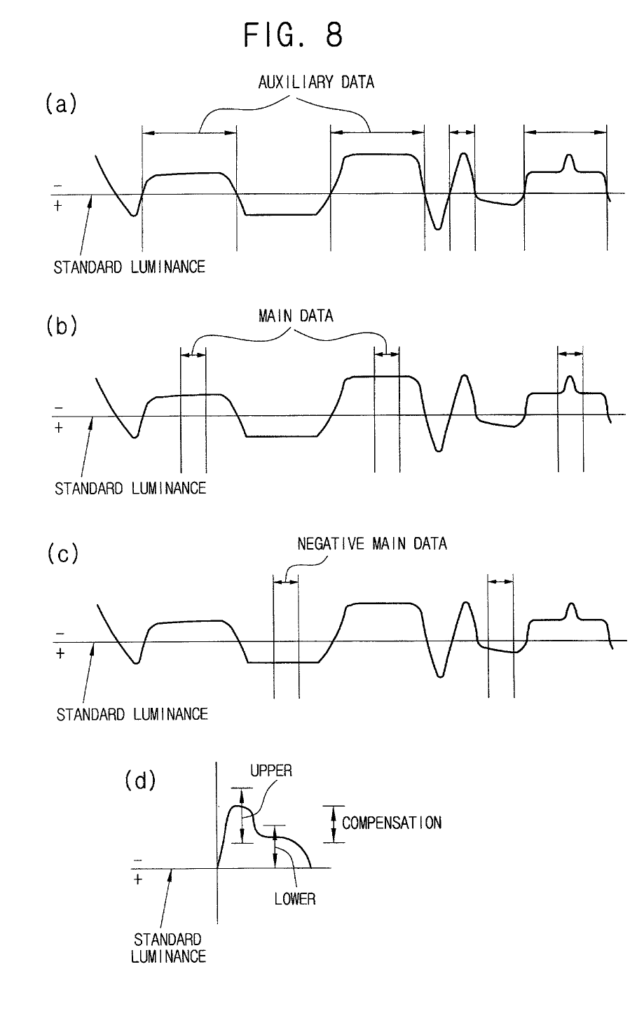

FIG. 8a˜FIG. 8d are drawings for illustrating for distribution of data in iris image and how the data is compensated.

The iris image is stored into the storage medium 40 in the unit of block after the every blocks are classified into a main, auxiliary, negative main data according to a pixel density of the blocks. In this case, the iris image data is stored as an absolute coordinates to the iris center.

As shown in FIG. 8a, areas of the iris image where the luminosities are less than a standard luminance are set as the auxiliary data, and any portion of the auxiliary data having the same luminance and where the pixel density is greater than a predetermined density value becomes main data (see FIG. 8b). The negative main data are portions where the pixel densities are less than a predetermined value among the areas of which the luminosities are greater than the standard luminance in the iris image (see FIG. 8c).

The auxiliary data is divided into two portions on the basis of a predetermined luminance level so as to set a portion near the lowest luminance level as an upper luminance level portion and to set a portion near the standard luminance as a lower luminance level portion such that the auxiliary data is stored with information on one of the upper and lower luminance level portions. Also, a compensation area is formed up and down from the predetermined division luminance level (see FIG. 8d) such that the data level of a dim iris image can be compensated through the exclusive-OR and logical multiply computation.

The auxiliary data is stored together with the corresponding absolute coordinates, Boolean information on which level the data belong to, and compensation information on a level dependency of the Boolean value.

For example, the compensation information is a Boolean data type such that when an associated portion of the luminance level of the image crosses the two levels or contacts one of both, the value becomes 1.

That is, the auxiliary data is an area where an areal pixel density ρₘ of a negative cognitive factor of the iris image is greater than that of the predetermined luminance standard point [symbol] (ρ_{m≧} [symbol] ).

The upper and lower levels (L₁) of the auxiliary data is 1 when

$${ρ}_{m} \geq \frac{1}{2} η$$

and 0 when

$${ρ}_{m} < \frac{1}{2} η .$$

The compensation level (L₂) is 1 or 0 when the auxiliary data satisfies the condition of

$$\frac{2}{5} η \leq {ρ}_{m} \leq \frac{3}{5} η .$$

The main data is the area where the number of the pixels (Sp) of the iris image is more than a number of standard pixels (Pₘₐₓ).

That is, Sp=π{(x₁−x₀)²+(y₁−y₀)²}≧Pₘₐₓ

where Xₘₐₓ≧(x₁−x₀), Yₘₐₓ≧(y₁−y₀), Pmax is standard pixel number, Xₘₐₓ is a limit of x axis length in pixel, Yₘₐₓ is a limit of y axis length in pixel, x₀ and y₀ are center coordinates of a polar coordinates system, and x₁ and y₁ are boundary coordinates of the polar coordinates system.

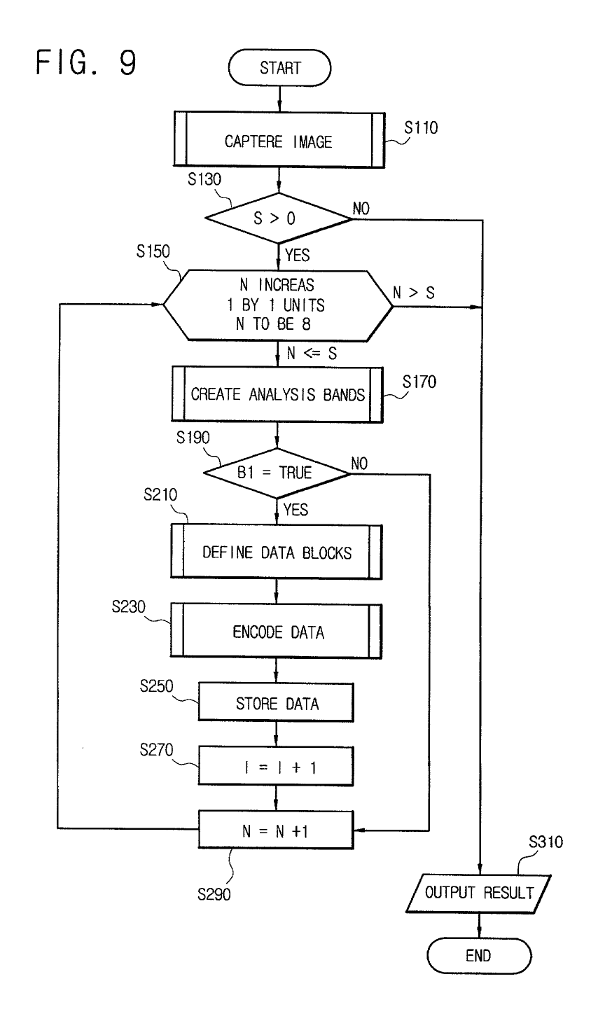

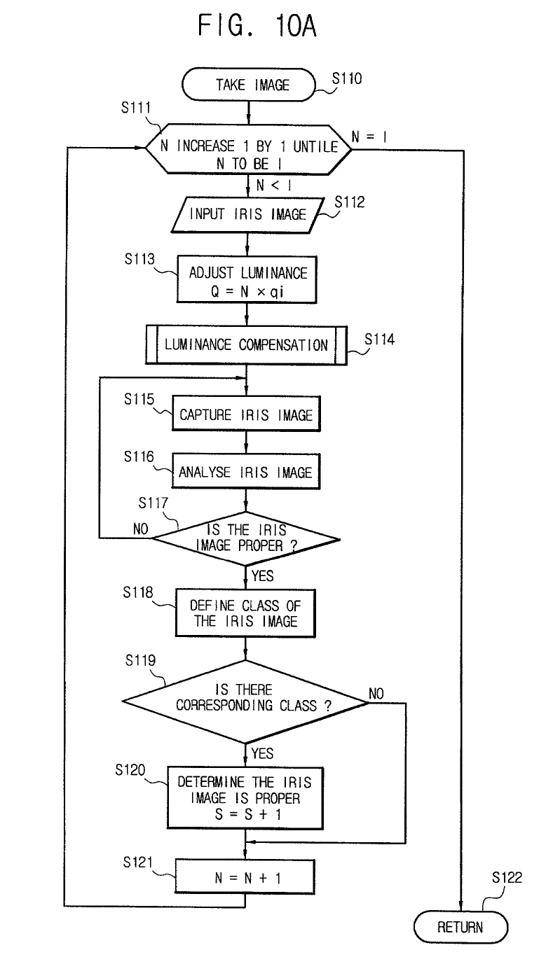

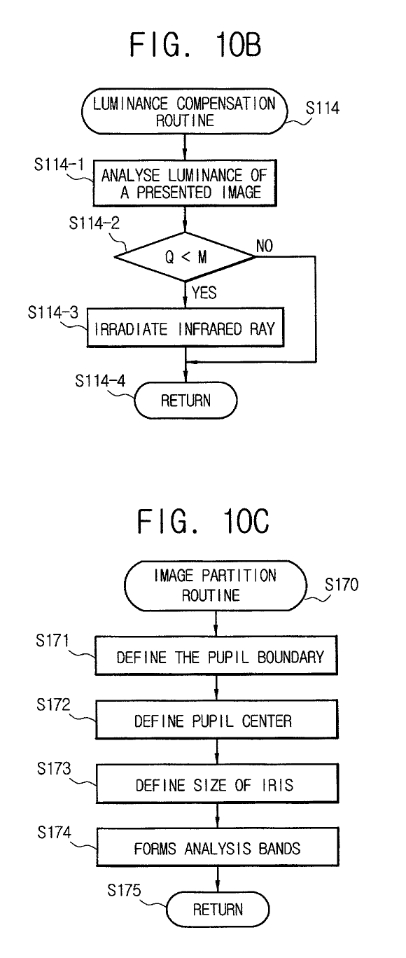

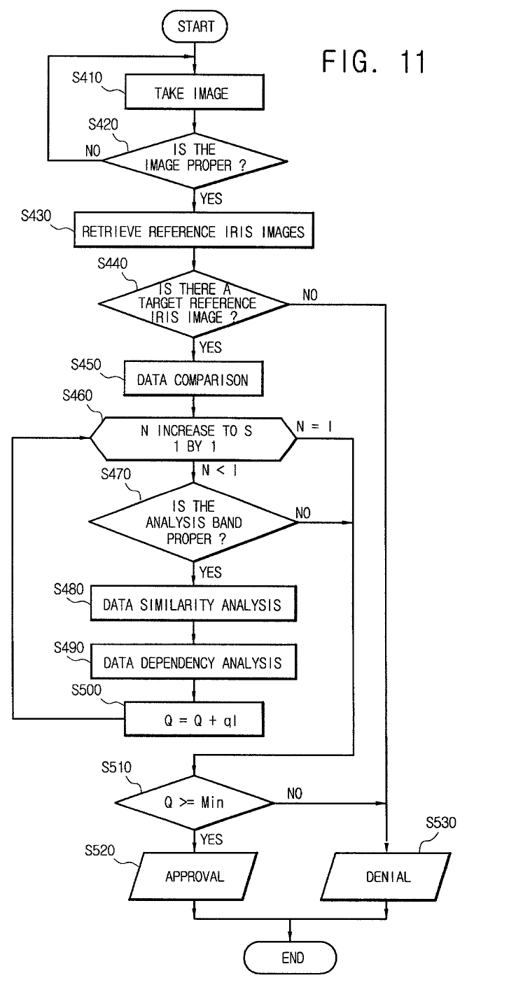

The process for registering a reference iris image by the registration according to a preferred embodiment of the present means will be described with reference to FIG. 9 and FIG. 10a, FIG. 10b, and FIG. 10c hereinafter.

Referring to FIG. 9, once the MCU 30 is set to the registration mode by the mode converter 20 and an iris image is inputted through the image input means 10, the registration module 51 of the image control unit 50 takes several iris instances having different pupil radius and classifies the iris instances into at least one class according to the pupil radius at step S110 and determines whether the number of the taken images (S) are greater than 0 at step S130. If the number of the taken image is 0, the registration module 51 outputs the result at step S310 and ends the registering algorithm. If the number of the taken image is greater than 0 at step S130, a counter (N) increases from 1 to 8 at step S150. At the same time, the registration module 51 vertically partitions each image so as to form a plurality of bands at step S170. Next, the registration module 51 determines whether or not the bands are successfully formed at step S190. If the bands are successfully formed, a variable B1 is set to TRUE. If the variable B1 is set to TRUE, the registration module 51 divides the bands so as to form symmetric blocks at step S210 and then store the iris image data into the storage medium 40 in the unit of block at step S250. While processing the iris image, the registration module 51 increases an image storing counter (I) and the image counter (N) one by one at step S270 and S290.

FIG. 10a is a flowchart for illustrating an image-taking routine of the reference iris image-registering process.

As shown in FIG. 10a, in an state where the variables are initialized once an iris image is inputted at step S112, while the luminance adjustment module 53 adjusts the intensity of the visible ray around the iris (Q=N×qi, wherein qi is a maximum luminance limit constant) to be registered and compensates the intensity of the visible ray at step S114 such that the pupil radium of the eye is adjusted at step S113, the registration module 51 captures effective images at step S115. Next, the registration module 51 analyzes the captured image and determines whether or not the iris image is appropriate as a reference iris image at step S117. If the iris image is not the appropriate one, the algorithm goes to step S115 and if the iris image is appropriate as the reference iris image, the registration module 51 classifies the iris images according to the pupil radius at step S118 and determines whether or not there exist a same image that belongs to the same class in the storage medium 40 at step S119. If the same image exists, the registration module determines that the image is suitable and increases the variables S and N by 1 at steps S120 and S121. At step S19, if the same image does not exist, the registration module 51 increases just the variable N by 1.

FIG. 10b is a flowchart for illustrating a luminance compensation routine at step S114 of FIG. 10a.

In the luminance compensation routine, the registration module 51 analyzes luminance Q of the presented image at step S114-1 and then determines whether or not the presented image luminance Q is less than a predetermined standard luminance M at step S114-2. If the presented image luminance Q is less than the standard luminance, the luminance adjustment module 53 irradiate infrared ray so as to adjust the image luminance at step S114-3.

FIG. 10c is a flowchart for illustrating an iris image-partitioning routine at step S170 of the reference iris image-registering process of FIG. 9.

In the iris image-partitioning routine, the registration module 51 defines the pupil boundary using the Equation 1 at step S171 and the center of the pupil through the Equations 2a ˜2b at step S172. Next, the registration module 51 defines the size of the iris on the basis of the pupil center and the pupil boundary at step S173. After the iris size is defined, the registration module 51 vertically partitions the iris image so as to form a plurality of bands at step S174.

FIG. 11 is a flowchart for illustrating an identification process of the iris identification method of the present invention.

Referring to FIG. 11, once the MCU 30 is set to the identification mode by the mode converter 20 and at least one iris image is inputted at step S410, the image analysis module 52 of the image control unit 50 determines whether or not the iris image is proper for comparison with the reference iris images at step S420. If the iris image is not proper, the identification algorithm returns to the step S410. If the iris image is proper at step S420, the image analysis module 52 retrieves corresponding reference iris class from the storage medium 40 at step S430 and determines whether or not the corresponding iris class exists in the storage medium 40 at step S440. If the corresponding iris class does not exist, the image analysis module outputs a denial message at step S530 and ends the identification session.

At step S440, if the corresponding iris class exists in the storage medium, the image analysis module 52 starts comparing the presented iris image with the reference iris images belonged to the corresponding iris class at step S450. While the data comparison, the image analysis module 52 creates vertical bands and sets data blocks so as to compare the presented iris image and the reference iris image in the unit of block at step S470. That is, the main, auxiliary, and negative main data of corresponding blocks of the presented iris image and the reference iris image are respectively compared. In this case, the comparison is performed at corresponding absolute coordinates in descendent order of the priority.

At step S470, if the band is inappropriate, the image analysis module 52 determines whether the luminance Q is equal to or greater than a predetermined value at step S510. If the condition is satisfied at step S510, the image analysis module 52 displays the approval result at step S520.

On the other hand, if the band is appropriate at step S470, the image analysis module 52 analyzes the equalities of main, auxiliary, and negative main data of the of each block (qI=Q) at step S480 and band dependency (qx) at step S490. In this case, the band dependency is weighted in accordance with the band priority of the data block. Consequently, if the presented iris image satisfies the condition of Q>Min at step S510, the image analysis module 52 outputs the identification result at step S520. On the other hand, if the presented image does not satisfy the condition, the image analysis module 52 outputs the denial result at step S530. The final result is expressed by the equality, that is an absolute element, together with adoption extent of the compensation level of the auxiliary data.

As described above, in the iris identification system and method according to the preferred embodiment of the present invention, an input iris image is stored in the several states as reference iris images that have different pupil sizes in order for each reference iris image to belong to a class in the registration mode, once an iris image is input for being verified, the input iris image is compared with a reference iris image belong to the corresponding class in the identification mode, and the input iris image is firstly regarded as just a candidate image even though corresponding reference iris images exist in the system and excludes further analysis especially when the pupil radium of the input image is different from that of the reference iris classes so as to considerably reduce the possibility of misidentification.

The misidentification rate (e) can be expressed as followings.

$$e = {( {2}^{\frac{A C {S}_{p}}{B}} )}^{- 1}$$

wherein, Sₚ is number of pixels of the iris, A is a percentage of the iris characteristic factor to the iris, B is a number of averaged pixel, and C is a percentage value of the band priority rate to the iris exposure.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An iris identification system comprising:
a mode converter for selecting one of registration and identification modes;
an image input means for capturing an iris image;
an image control unit for registering a plurality of instances of the iris image captured in the image input means as reference iris images in the registration mode and retrieving a corresponding reference iris image when an iris image is presented to the image input means in the identification mode;
an iris reference iris image storage for storing the registered reference iris images; and
a main control unit for controlling the image input means, mode converter, image control unit and the iris reference iris image storage so as to cooperates one another.

2. An iris identification system of claim 1 wherein the image control unit comprises:
a registration module for registering the instances as the iris reference samples; and
an image analysis module for retrieving the corresponding reference iris image when the iris image is presented to the image input means and analyzing similarity between the presented iris image and the retrieved reference iris image.

3. An iris identification system of claim 2 further comprises a luminance adjustment module for detecting luminance of the input image and adjusting the luminance around an eyepiece of the image input means.

4. An iris identification system of claim 3 wherein the iris instances have different pupil radius.

5. An iris identification system of claim 4 wherein the pupil radium is adjusted by the luminance adjustment module adjusting luminance around the eyepiece of the image input means using visible ray.

6. An iris identification system of claim 5 wherein the luminance adjustment module further adjusts the luminance using invisible ray when the luminance is less than a predetermined threshold level.

7. An iris identification system of claim 2 wherein the registration module takes the instances having predetermined pupil radius, classifies the instances into at least one class, and stores the instances as reference iris images with class information.

8. An iris identification system of claim 7 wherein each reference iris image belonged to a class is vertically divided so as to form a plurality of horizontal bands and the horizontal bands are divided by a perpendicular line passing through a center of the pupil such that a plurality of blocks are symmetrically formed.

9. An iris identification system of claim 8 wherein the classes are defined by dividing a distance between minimum pupil radium and maximum pupil radium by a predetermined interval in a range of the iris radium.

10. An iris identification system of claim 7 wherein the reference iris image is stored as absolute coordinates data in relation with the center of the pupil.

11. An iris identification system of claim 8 wherein the horizontal bands have priorities assigned in a predetermined order.

12. An iris identification system of claim 11 wherein a size of the block is determined according to where the block locates in the range of iris radium.

13. An iris identification system of claim 12 wherein the block comprises a main, auxiliary, and negative main data that are defined by pixel density.

14. An iris identification system of claim 13 wherein the auxiliary data has a luminance less than a predetermined standard luminance and the main data are the data that have a pixel density greater than a predetermined standard pixel density among the auxiliary data.

15. An iris identification system of claim 13 wherein the negative main data are the data that have a pixel density less than the predetermined standard pixel density among data that have a luminance greater than the predetermined standard luminance.

16. An iris identification system of claim 14 wherein the auxiliary data is divided into an upper and lower level portions on the basis of a predetermined luminance level.

17. An iris identification system of claim 18 wherein the upper level portion is defined between the predetermined luminance level and a lowest luminance level, and the lower level portion is defined between the predetermined luminance level and the standard luminance level such that the auxiliary data is stored as one of the upper and lower levels.

18. An iris identification system of claim 17 wherein a compensation area is defined around the predetermined luminance level such that a data level of a vague iris image can be compensated through exclusive-OR and logical multiply computation using the compensation level.

19. An iris identification system of claim 10 wherein a center of the pupil is calculated in such an order of obtaining a plurality of random pupil centers Iᵢ, extracting candidate pupil centers from the random pupil centers, calculating a final pupil center Tₚ (xₚ, yₚ) using the candidate pupil centers.

20. An iris identification system of claim 19 wherein the random pupil center Iᵢ is obtained in such a manner of randomly selecting two points of S(x₁, y₁) and E(x₂, y₂) on an actual pupil boundary, creating a segment SE by drawing a line connecting the points S and E, drawing a perpendicular line from a center of the segment SE such that the perpendicular line crosses the pupil boundary at a point C(x₃, y₃), and calculating the random pupil center on the basis of arc SE and point C thereon.

21. An iris identification system of claim 19 wherein the random pupil center I_{I}(x₀, y₀) is obtained as following calculations:
$$a = \frac{1}{2} \sqrt{{( {x}_{1} - {x}_{2} )}^{2} + {( {y}_{1} - {y}_{2} )}^{2}} , \\ c = \frac{1}{2} \sqrt{{( {x}_{1} + {x}_{2} - 2 {x}_{3} )}^{2} + {( {y}_{1} + {y}_{2} - 2 {y}_{3} )}^{2}}$$
$$d = \frac{1}{2 c} ( {a}^{2} - {c}^{2} ) , \\ D = {tan}^{- 1} ( \frac{{y}_{1} - {y}_{2}}{{x}_{1} - {x}_{2}} ) - \frac{π}{2} , \\ {x}_{0} = d \cdot cos D + \frac{1}{2} ( {x}_{1} + {x}_{2} ) , and$$
$${y}_{0} = - ( d \cdot sin D + \frac{1}{2} ( {y}_{1} + {y}_{2} ) ) .$$

22. An iris identification system of claim 21 wherein the candidate pupil centers have radius that are in whole class range β.

23. An iris identification system of claim 22 wherein the final pupil center Tₚ(xₚ, yₚ) is obtained as following calculations:
$${x}_{p} = \frac{1}{n} \sum {x}_{0 i}$$
$${y}_{p} = \frac{1}{n} \sum {y}_{0 i} .$$

24. An iris identification system of claim 23 wherein the registration module determines a pupil boundary as following equation,
when Iₘₘ<I_{b}<Iₘₐ,
$${I}_{mb} = \frac{1}{{N}_{b}} \sum {I}_{b}$$
$$where {I}_{ma} = \frac{1}{{N}_{a}} \sum {I}_{a} , {I}_{a} ( {I}_{b} )$$
is luminance of a pixel, Iₘₐ(I_{mb}) is an average luminance, Nₐ(N_{b}) is number of executions, and Iₘᵢₙ is a minimum luminance limit.

25. An iris identification system of claim 2 wherein the image analysis module retrieves a target class when the iris image is presented to the image input means and retrieves a target reference iris image in the class if the target class exists.

26. An iris identification system of claim 25 wherein the image analysis module partitions the presented iris image into a plurality of horizontal bands, creates data blocks by symmetrically dividing the bands, and codes the data blocks with a main, auxiliary, and negative main data.

27. An iris identification system of claim 26 wherein the image analysis module compares the presented iris image with the target reference iris image and analyzes data similarity and band dependency.

28. An iris identification system of claim 27 wherein the image analysis module determines whether the presented iris image satisfies condition of a predetermined security level on the basis of result from the analysis of the similarity and band dependency.

29. An iris identification system of claim 28 wherein the image analysis module takes more than one iris images having different pupil radius for preventing misidentification or usage of a forged inorganic iris.

30. An iris identification system of claim 29 wherein the pupil radius is adjusted by adjusting luminance around an eyepiece of the image input means using visible ray.

31. An iris identification system of claim 30 wherein the luminance around eyepiece is further adjusted using invisible ray if the adjusted luminance is lower than a predetermined luminance.

32. An iris identification system of claim 25 wherein the image analysis module immediately outputs denial result if the target class does not exist.

33. An iris identification system of claim 25 wherein the image analysis module scales the presented image as in corresponding iris image size if the target class exists.

34. An iris identification system of claim 33 wherein the image analysis module compares the presented image and the target reference iris image in unit of block in consideration with absolute positions of the blocks.

35. An iris identification system of claim 34 wherein the image analysis module classifies data in the block into main, auxiliary, and negative main data according to pixel density and assigns a band priority.

36. An iris identification system of claim 35 wherein the image analysis module analyzes similarity of corresponding main, auxiliary, and negative main data of the blocks by reflecting the band priority, determines whether or not the similarity satisfies a predetermined condition of the security, and outputs analysis result for identification.

37. An iris identification system of claim 36 wherein the image analysis module gives the block similarity weight according to the band priority of the block.

38. An iris identification system of claim 37 wherein the image analysis module reflects the data similarities of the main, auxiliary, and negative main data to the final result as absolute factors.

39. An iris identification system of claim 36 wherein the image analysis module reflects data similarities of upper and lower level and compensation level of the auxiliary data to the final result.

40. An iris identification system of claim 39 wherein the image analysis module outputs the final result together with a reflection degree of the compensation level of the auxiliary data.

41. An iris identification method comprising the steps of:
(a) taking a plurality of iris images from a human eye through an input means;
(b) classifying the iris images into at least one class;
(c) registering the iris images to corresponding classes as reference iris images per the human eye;
(d) storing the reference iris images in a storage medium;
(e) receiving a plurality of iris instances of a person for identification;
(f) retrieving target reference iris image by comparing each iris instance to reference iris images in a corresponding class;
(g) determining whether the iris instance is identified or denied.

42. An iris identification method of claim 41 further comprises the step of selecting the iris images having different pupil radius to the identical human eye after the step (a).

43. An iris identification method of claim 42 further comprises the step of adjusting pupil radium for taking iris images having different pupil radius.

44. An iris identification method of claim 43 wherein the pupil radium is adjusted by controlling luminance around an eyepiece of the image input means.

45. An iris identification method of claim 44 wherein the luminance is adjusted by irradiating visible ray around the eyepiece.

46. An iris identification method of claim 45 wherein the luminance is further adjusted by irradiating invisible ray if the luminance is lower than a predetermined standard luminance.

47. An iris identification method of claim 41 wherein the classes are defined according to the pupil radius.

48. An iris identification method of claim 41 wherein the step (d) comprises the steps of:
(d1) vertically dividing each iris image on the basis of horizontal line passing the center of the pupil for forming a plurality of bands;
(d2) creating data blocks by symmetrically dividing the bands;
(d3) encoding the iris image in unit of block;
(d4) storing the iris image as the reference iris image.

49. An iris identification method of claim 47 wherein the classes are defined by dividing a distance between minimum pupil radium and maximum pupil radium by a predetermined interval in a range of an iris radium.

50. An iris identification method of claim 49 wherein the iris image is stored as absolute coordinates data in relation to the center of the pupil.

51. An iris identification method of claim 50 wherein the iris image is stored together with information of the bands.

52. An iris identification method of claim 51 wherein the information of the band includes reference priority.

53. An iris identification method of claim 52 wherein the bands are symmetrically divided by a vertical line passing the center of the pupil so as to create a plurality of blocks.

54. An iris identification method of claim 53 wherein the blocks have different sizes according to locations thereof in space between the pupil and iris boundaries.

55. An iris identification method of claim 54 wherein the block contains a main, auxiliary, and negative main data classified by pixel density.

56. An iris identification method of claim 53 wherein the auxiliary data is an area where luminance of the area is less than a predetermined standard luminance and the main data is a portion of the auxiliary data where the pixel density is greater than a predetermined value.

57. An iris identification method of claim 55 wherein the negative main data is a portion where the pixel density is greater than a predetermined standard value in an area of which luminance is greater than the predetermined standard luminance.

58. An iris identification method of claim 56 wherein the auxiliary data is divided into upper and lower luminance level portions on the basis of a predetermined division luminance level such that the auxiliary data is stored with information on one of the upper and lower luminance level portions.

59. An iris identification method of claim 58 wherein the auxiliary data has a compensation level portion formed around the predetermined division luminance level such that data level of a vague iris image is compensated with the compensation level.

60. An iris identification method of claim 50 wherein the pupil center is calculated in such an order of obtaining a plurality of random pupil centers I_{I}, extracting candidate pupil centers from the random pupil centers, calculating a final pupil center Tₚ (xₚ, yₚ) using the candidate pupil centers.

61. An iris identification method of claim 60 wherein the random pupil center I_{I}, is obtained in such a manner of randomly selecting two points of S(x₁, y₁) and E(x₂, Y₂) on an actual pupil boundary, creating a segment SE by drawing a line connecting the points S and E, drawing a perpendicular line from a center of the segment SE such that the perpendicular line crosses the pupil boundary at a point C(x₃, y₃), and calculating the random pupil center on the basis of arc SE and point C thereon.

62. An iris identification method of claim 61 wherein the random pupil center Iᵢ(x₀, y₀) is obtained as following calculations:
$$a = \frac{1}{2} \sqrt{{( {x}_{1} - {x}_{2} )}^{2} + {( {y}_{1} - {y}_{2} )}^{2}} , \\ c = \frac{1}{2} \sqrt{{( {x}_{1} + {x}_{2} - 2 {x}_{3} )}^{2} + {( {y}_{1} + {y}_{2} - 2 {y}_{3} )}^{2}}$$
$$d = \frac{1}{2 c} ( {a}^{2} - {c}^{2} ) , \\ D = {tan}^{- 1} ( \frac{{y}_{1} - {y}_{2}}{{x}_{1} - {x}_{2}} ) - \frac{π}{2} , \\ {x}_{0} = d \cdot cos D + \frac{1}{2} ( {x}_{1} + {x}_{2} ) , and$$
$${y}_{0} = - ( d \cdot sin D + \frac{1}{2} ( {y}_{1} + {y}_{2} ) ) .$$

63. An iris identification system of claim 62 wherein the candidate pupil centers have radius that are in whole class range β.

64. An iris identification system of claim 63 wherein the final pupil center Tₚ(xₚ, yₚ) is obtained as following calculations:
$${x}_{p} = \frac{1}{n} \sum {x}_{0 i}$$
$${y}_{p} = \frac{1}{n} \sum {y}_{0 i} .$$

65. An iris identification system of claim 64 wherein a pupil boundary as following equation is calculated as following equation:
when Iₘᵢₙ<I_{b}<Iₘₐ,
$${I}_{mb} = \frac{1}{{N}_{b}} \sum {I}_{b}$$
$$where {I}_{ma} = \frac{1}{{N}_{a}} \sum {I}_{a} , {I}_{a} ( {I}_{b} )$$
is luminance of a pixel, I ₘₐ(I_{mb}) is an average luminance, Nₐ(N_{b}) is number of executions, and Iₘᵢₙ is a minimum luminance limit.

66. An iris identification method of claim 41 further comprises the steps of retrieving a target class when the iris image is presented and retrieving a target reference iris image in the class if the target class exists.

67. An iris identification method of claim 66 wherein the presented image is divided into a plurality of horizontal bands and the bands are divided in order for the bands are divided into symmetrical blocks such that the blocks are coded with main, auxiliary, and negative main data.

68. An iris identification method of claim 67 wherein the presented iris image is compared with the target reference iris image and analyzed in data similarity and band dependency.

69. An iris identification method of claim 68 wherein more than one iris images having different pupil radius are taken for preventing misidentification or usage of a forged inorganic iris.

70. An iris identification method of claim 69 wherein the pupil radius is adjusted by controlling luminance around an eye to provide the iris image using visible ray.

71. An iris identification method of claim 70 wherein the luminance is adjusted using invisible ray if the adjusted luminance is lower than a predetermined luminance.

72. An iris identification method of claim 66 wherein if the target class does not exist, a denial result is immediately outputted.

73. An iris identification method of claim 72 wherein the target reference iris image is retrieved in a class corresponding to the class of the presented iris image.

74. An iris identification method of claim 73 wherein if the garget class exists, the presented image is scaled in corresponding image size.

75. An iris identification method of claim 74 wherein the presented image and the target reference iris image are compared in unit of data block in consideration with absolute positions of the blocks.

76. An iris identification method of claim 75 wherein data of the block are classified into main, auxiliary, and negative main data according to pixel density and the block is assigned with a band priority.

77. An iris identification method of claim 76 wherein similarities of corresponding main, auxiliary, and negative main data of the block are analyzed by reflecting the band priority so as to be determined whether or not the similarity satisfies a predetermined condition of the security, and analysis result is outputted.

78. An iris identification method of claim 77 wherein the block is assigned with a similarity weight according to the band priority of the block.

79. An iris identification method of claim 78 wherein the data similarities of the main, auxiliary, and negative main data is reflected to final analysis result as absolute factors.

80. An iris identification method of claim 79 wherein the data similarities of upper and lower level an compensation level of the auxiliary data is reflected to the final analysis result.

81. An iris identification method of claim 80 wherein the final result is outputted together with a reflection degree of the compensation level of the auxiliary data.

82. A computer readable storage medium stored therein computer executable instructions to implement an iris identification method, the iris identification method comprising the processes of:
taking a plurality of iris images from a human eye through an input means;
classifying the iris images into at least one class;
registering the iris images to corresponding classes as reference iris images per the human eye;
storing the reference iris images in a storage medium;
receiving a plurality of iris instances of a person for identification;
retrieving target reference iris image by comparing each iris instance to reference iris images in a corresponding class;
determining whether the iris instance is identified or denied.

83. A computer readable storage medium of claim 82 wherein the iris identification method further comprises a process of selecting the iris images having different pupil radius to an identical human eye.

84. A computer readable storage medium of claim 83 wherein the iris identification method further comprises a process of adjusting pupil radium for taking iris images having different pupil radius.

85. A computer readable storage medium of claim 84 wherein the pupil radium is adjusted by controlling luminance around an eyepiece of the image input means.

86. A computer readable storage medium of claim 85 wherein the luminance is adjusted by irradiating visible ray around the eyepiece.

87. A computer readable storage medium of claim 86 wherein the luminance is further adjusted by irradiating invisible ray if the luminance is lower than a predetermined standard luminance.

88. A computer readable storage medium of claim 82 wherein the classes are defined according to the pupil radius.

89. A computer readable storage medium of claim 82 wherein the process for storing the reference iris images in a storage medium comprises the steps of:
vertically dividing each iris image on the basis of horizontal line passing the center of the pupil for forming a plurality of bands;
creating data blocks by symmetrically dividing the bands;
encoding the iris image in unit of block;
storing the iris image as the reference iris image.

90. A computer readable storage medium of claim 88 wherein the classes are defined by dividing a distance between minimum pupil radium and maximum pupil radium by a predetermined interval in a range of an iris radium.

91. A computer readable storage medium of claim 89 wherein the iris image is stored as absolute coordinates data in relation to the center of the pupil.

92. A computer readable storage medium of claim 51 wherein the iris image is stored together with information of the bands.

93. A computer readable storage medium of claim 92 wherein the information of the band includes reference priority.

94. A computer readable storage medium of claim 93 wherein the bands are symmetrically divided by a vertical line passing the center of the pupil so as to create a plurality of blocks.

95. A computer readable storage medium of claim 94 wherein the blocks have different sizes according to locations thereof in space between the pupil and iris boundaries.

96. A computer readable storage medium of claim 95 wherein the block contains a main, auxiliary, and negative main data classified by pixel density.

97. A computer readable storage medium of claim 95 wherein the the auxiliary data is an area where luminance of the area is less than a predetermined standard luminance and the main data is a portion of the auxiliary data where the pixel density is greater than a predetermined value.

98. A computer readable storage medium of claim 97 wherein the negative main data is a portion where the pixel density is greater than a predetermined standard value in an area of which luminance is greater than the predetermined standard luminance.

99. A computer readable storage medium of claim 98 wherein the auxiliary data is divided into upper and lower luminance level portions on the basis of a predetermined division luminance level such that the auxiliary data is stored with information on one of the upper and lower luminance level portions.

100. A computer readable storage medium of claim 99 wherein the auxiliary data has a compensation level portion formed around the predetermined division luminance level such that data level of a vague iris image is compensated with the compensation level.

101. A computer readable storage medium of claim 91 the pupil center is calculated in such an order of obtaining a plurality of random pupil centers I_{I}, extracting candidate pupil centers from the random pupil centers, calculating a final pupil center Tₚ(xₚ, yₚ) using the candidate pupil centers.

102. A computer readable storage medium of claim 101 wherein the random pupil center I_{I} is obtained in such a manner of randomly selecting two points of S(x₁, y₁) and E(x₂, y₂) on an actual pupil boundary, creating a segment SE by drawing a line connecting the points S and E, drawing a perpendicular line from a center of the segment SE such that the perpendicular line crosses the pupil boundary at a point C(x₃, y₃), and calculating the random pupil center on the basis of arc SE and point C thereon.

103. A computer readable storage medium of claim 102 wherein the random pupil center I_{I}(x₀, y₀) is obtained as following calculations:
$$a = \frac{1}{2} \sqrt{{( {x}_{1} - {x}_{2} )}^{2} + {( {y}_{1} - {y}_{2} )}^{2}} , \\ c = \frac{1}{2} \sqrt{{( {x}_{1} + {x}_{2} - 2 {x}_{3} )}^{2} + {( {y}_{1} + {y}_{2} - 2 {y}_{3} )}^{2}}$$
$$d = \frac{1}{2 c} ( {a}^{2} - {c}^{2} ) , \\ D = {tan}^{- 1} ( \frac{{y}_{1} - {y}_{2}}{{x}_{1} - {x}_{2}} ) - \frac{π}{2} , \\ {x}_{0} = d \cdot cos D + \frac{1}{2} ( {x}_{1} + {x}_{2} ) , and$$
$${y}_{0} = - ( d \cdot sin D + \frac{1}{2} ( {y}_{1} + {y}_{2} ) ) .$$

104. A computer readable storage medium of claim 103 wherein the candidate pupil centers have radius that are in whole class range β.

105. A computer readable storage medium of claim 104 wherein the final pupil center Tₚ(xₚ, yₚ) is obtained as following calculations:
$${x}_{p} = \frac{1}{n} \sum {x}_{0 i}$$
$${y}_{p} = \frac{1}{n} \sum {y}_{0 i} .$$

106. A computer readable storage medium of claim 104 wherein a pupil boundary as following equation is calculated as following equation:
when Iₘᵢₙ<I_{b}<Iₘₐ
$${I}_{mb} = \frac{1}{{N}_{b}} \sum {I}_{b}$$
where
$${I}_{ma} = \frac{1}{{N}_{a}} \sum {I}_{a} , {I}_{a} ( {I}_{b} )$$
is luminance of a pixel, Iₘₐ(I_{mb}) is an average luminance, Nₐ(N_{b}) is number of executions, and Iₘᵢₙ is a minimum luminance limit.

107. A computer readable storage medium of claim 82 wherein the iris identification method further comprises the processes of retrieving a target class when the iris image is presented and retrieving a target reference iris image in the class if the target class exists.

108. A computer readable storage medium of claim 107 wherein the presented image is divided into a plurality of horizontal bands and the bands are divided in order for the bands are divided into symmetrical blocks such that the blocks are coded with main, auxiliary, and negative main data.

109. A computer readable storage medium of claim 108 wherein the presented iris image is compared with the target reference iris image and analyzed in data similarity and band dependency.

110. A computer readable storage medium of claim 109 wherein more than one iris images having different pupil radius are taken for preventing misidentification or usage of a forged inorganic iris.

111. A computer readable storage medium of claim 110 wherein the pupil radius is adjusted by controlling luminance around an eye to provide the iris image using visible ray.

112. A computer readable storage medium of claim 111 wherein the luminance is adjusted using invisible ray if the adjusted luminance is lower than a predetermined luminance.

113. A computer readable storage medium of claim 112 wherein if the target class does not exist, a denial result is immediately outputted.

114. A computer readable storage medium of claim 113 wherein the target reference iris image is retrieved in a class corresponding to the class of the presented iris image.

115. A computer readable storage medium of claim 114 wherein if the garget class exists, the presented image is scaled in corresponding image size.

116. A computer readable storage medium of claim 115 wherein the presented image and the target reference iris image are compared in unit of data block in consideration with absolute positions of the blocks.

117. A computer readable storage medium of claim 116 wherein data of the block are classified into main, auxiliary, and negative main data according to pixel density and the block is assigned with a band priority.

118. A computer readable storage medium of claim 117 wherein similarities of corresponding main, auxiliary, and negative main data of the block are analyzed by reflecting the band priority so as to be determined whether or not the similarity satisfies a predetermined condition of the security, and analysis result is outputted.

119. A computer readable storage medium of claim 118 wherein the block is assigned with a similarity weight according to the band priority of the block.

120. A computer readable storage medium of claim 119 wherein the data similarities of the main, auxiliary, and negative main data is reflected to final analysis result as absolute factors.

121. A computer readable storage medium of claim 120 wherein the data similarities of upper and lower level an compensation level of the auxiliary data is reflected to the final analysis result.

122. A computer readable storage medium of claim 121 wherein the final result is outputted together with a reflection degree of the compensation level of the auxiliary data.
